(19) United States
(12) Patent Application Publication
(10) Pub. No.: US 2002/0159513 A1
(43) Pub. Date: Oct. 31, 2002

(54) System and method for shared cable upstream bandwidth

(76) Inventors: Thomas H. Williams, Longmont, CO (US); Mukta L. Kar, Superior, CO (US); Majid Chelehmal, Broomfield, CO (US)

Correspondence Address: The Law Offices of William W. Cochran, LLC, Suite 230, 3555 Stanford Road, Fort Collins, CO, 80525, US

(21) Appl. No.: 10/116,739

(22) Filed: Apr. 3, 2002

Related U.S. Application Data
(60) Provisional application No. 60/281,934, filed on Apr. 6, 2001.

(51) Int. Cl. H04B 1/38

(52) U.S. Cl. 375/222; 375/257

(57) ABSTRACT

Disclosed is a system and method that allows a plurality of modems to transfer data simultaneously within a single frequency channel of a cable. Each modem is assigned a frequency band within the frequency channel. A receiving unit captures a block of data from the frequency channel, processes the data and separates data for each frequency band. Data for each frequency band is demodulated to recover encoded data. The receiving unit may process a plurality of channels. Simultaneous transfer of data by a plurality of modems within a single channel may be employed to carry a plurality of simultaneous lower-speed data streams such as voice conversations. The frequency of a band employed for voice information transfer may be reassigned if the band is scheduled for other transmission or exhibits an error rate greater than or equal to a predetermined value.

### CROSS REFERENCE TO RELATED APPLICATIONS

This application is based upon and claims the benefit of U.S. provisional application No. 60/281,934, entitled “TECHNIQUE TO ALLOW LOW-SPEED AND HIGH-SPEED MODEMS TO SHARE OVERLAPPING BANDWIDTH ON A CABLE UPSTREAM SYSTEM,” filed Apr. 6, 2001 by Thomas H. Williams, Mukta L. Kar and Majid Chelehmal, the entire disclosure of which is herein specifically incorporated by reference for all that it discloses and teaches.

### BACKGROUND OF THE INVENTION

1. Field of the Invention

The present invention pertains to digital data transferred over a network and more specifically to increased bandwidth for upstream communications employed in a cable television network system.

2. Description of the Background

Cable television networks are frequently employed to provide both television programs and data services. Television programs, employing analog or digital broadcast formats, typically utilize a majority of the bandwidth of the network. Data services, such as personal computer Internet access or set top box interactions, employ cable modems to transfer digital data. Data transmission over cable may conform to standards such as DOCSIS (Data Over Cable System Interface Specification). The DOCSIS 1.0 specification defines a protocol utilizing a maximum upstream bandwidth of 3.2 MHz that corresponds to a maximum symbol rate of 2560 k symbols per second. As transfer of voluminous data files, such as photographs, audio files, and video images, becomes more pervasive, a faster rate of transfer is desired. One method of transferring data at a higher rate would be to increase the symbol rate. However compliance with the DOCSIS specification would not be maintained. Additionally, present transmission practice is that one modem transmits in each timeslot of a channel. If a modem does not utilize the full bandwidth of the channel, the unused bandwidth is not available to other users. Applications such as the transfer of voice information, require the transfer of frequent short bursts of data with low latency. This tends to waste available bandwidth. The ability of a cable system operator to offer transfer rates that are significantly higher than may be achieved through dial up services is central to attracting customers. Low utilization of available bandwidth requires that the system operator install hardware and software to support additional CMTS (Cable Modem Termination System) channels, resulting in higher cost. Therefore a new method is needed that allows greater utilization of available bandwidth and that is well suited to voice data transfers.

### SUMMARY OF THE INVENTION

The present invention overcomes the disadvantages and limitations of the prior art by providing a system and method wherein a plurality of modems, or other end user equipment, may transmit upstream data simultaneously in one or more timeslots within the frequency range of a single CMTS channel. Advantageously, the method of the invention provides higher system bandwidth utilization and lower latency without requiring changes to end user equipment and which is backward compatible with existing end user equipment. End user equipment may comprise modems, set top boxes, or any other systems capable of transmitting data upstream on a cable channel.

The present invention therefore may comprise a method of transferring data from a plurality of modems upstream in a cable network in timeslots having a predetermined maximum bandwidth comprising: receiving requests to transmit said data from the plurality of modems on a cable modem termination system that includes information relating to operational parameters of the plurality of modems, required bandwidth of the transmission and priority data, selecting channels and sub-channels for the plurality of modems based upon the operational parameters of the plurality of modems by the required bandwidth and the priority data, and assigning the channels and sub-channels by assigning center frequencies and bandwidth for each of the modems in the timeslots.

The present invention therefore may also comprise a method of transferring data upstream over a cable network comprising: configuring a first cable modem to transmit at a first carrier frequency providing a first bandwidth during at least one timeslot, configuring a second cable modem to transmit at a second carrier frequency and at a second bandwidth during the timeslot wherein the first bandwidth is not equal to the second bandwidth, and the first and second carrier frequencies are within a single channel of the cable network, transmitting first data from the first modem at the first carrier frequency during the timeslot, and transmitting second data from the second modem at the second carrier frequency during the timeslot.

The present invention may further comprise a method of transferring data over a cable network comprising: receiving a plurality of data transfer requests from a plurality of modems, assessing bandwidth available for data transfers, allocating a first sub-channel and a plurality of first timeslots to a first modem in response to the amount of bandwidth requested, and allocating a second sub-channel and a plurality of second timeslots to a second modem in response to the amount of bandwidth requested by the second modem wherein the first sub-channel and the second sub-channel are within a single cable system upstream channel and the first and second sub-channels are of different bandwidth, and at least one of the first plurality of timeslots coincides with at least one of the second plurality of timeslots.

The present invention is well suited to the transfer of voice information over cable system networks. The support of simultaneous transmission by a plurality of modems within a single channel offers efficient use of available bandwidth. Further, if a frequency band employed for the transfer of voice information is employed for other data transfer, such as set top box polling, for example, or if the frequency band exhibits excessive noise, as may be indicated by an error rate greater than or equal to a predetermined value, a different frequency band may be assigned for such transfers.

The invention therefore may also further comprise a method for transferring voice data across a cable network comprising: receiving a request from a first cable modem for voice information transfer, receiving a request from a second cable modem for voice information transfer, configuring the first cable modem to transmit first voice information in a first sub-channel contained within a cable system upstream channel, configuring the second cable modem to transmit second voice information in a second sub-channel contained within the cable system upstream channel, wherein the first sub-channel and the second sub-channel are of different frequencies, allocating a first plurality of contiguous timeslots to the first modem, and allocating a second plurality of contiguous timeslots to the second modem wherein at least one timeslot of the first plurality of timeslots is concurrent with at least one timeslot of the second plurality of timeslots.

By allowing a plurality of modems to simultaneously transmit within the frequency range of a single channel, additional users may be supported from a single node or hub, and additional services may be provided. This may result in greater revenue generation and increased customer satisfaction. Simultaneity of transmission may also encompass voice and data transfers, allowing for collaborative interaction.

The invention may additionally comprise a system for transferring information across a cable network comprising: a first cable modem that transmits first data in a first sub-channel in a cable system upstream channel at a predetermined time, a second cable modem that transmits second data in a second sub-channel in the cable system upstream channel at the predetermined time wherein the bandwidth of the first sub-channel is not equal to the bandwidth of the second sub-channel, a receiver that receives transmissions in the channel, a digitizer that digitizes the transmissions to produce a data block, and a processing unit that processes the data block to retrieve the first data and the second data.

Advantageously, the system and method of the present invention are compatible with existing equipment including cable modems, set top boxes, interactive televisions and other equipment that communicates across a cable television network. Such compatibility also allows partial or gradual installation of equipment employing the present invention in hub, node, or headend based CMTS architectures, allowing a cable system operator to optimize return on investment.

### DESCRIPTION OF THE FIGURES

In the figures,

FIG. 1 illustrates a cable television network topology.

FIG. 2 depicts NTSC cable television frequencies.

FIG. 3 is a depiction of DOCSIS 1.0 compliant modem upstream data transmission.

FIG. 4 is a second depiction of modem upstream data transmission.

FIG. 5 depicts upstream data transmission in a manner of the present invention.

FIG. 6 depicts upstream data transmission in another manner of the present invention.

FIG. 7 illustrates a center frequency for each modem.

FIG. 8 depicts a method of servicing modem data transfer requests in accordance with the present invention.

FIG. 9 depicts processing performed by a channel receiver of the present invention.

FIG. 10 depicts a cable television network channel configured for voice information transfer employing the present invention.

FIG. 11 depicts a cable television upstream channel configured to support 64 voice channels.

FIG. 12 depicts a cable television upstream channel configured to support 64 voice channels with band relocation.

FIG. 13 depicts an ‘always on’ configuration for 64 voice channels.

### DETAILED DESCRIPTION OF THE INVENTION

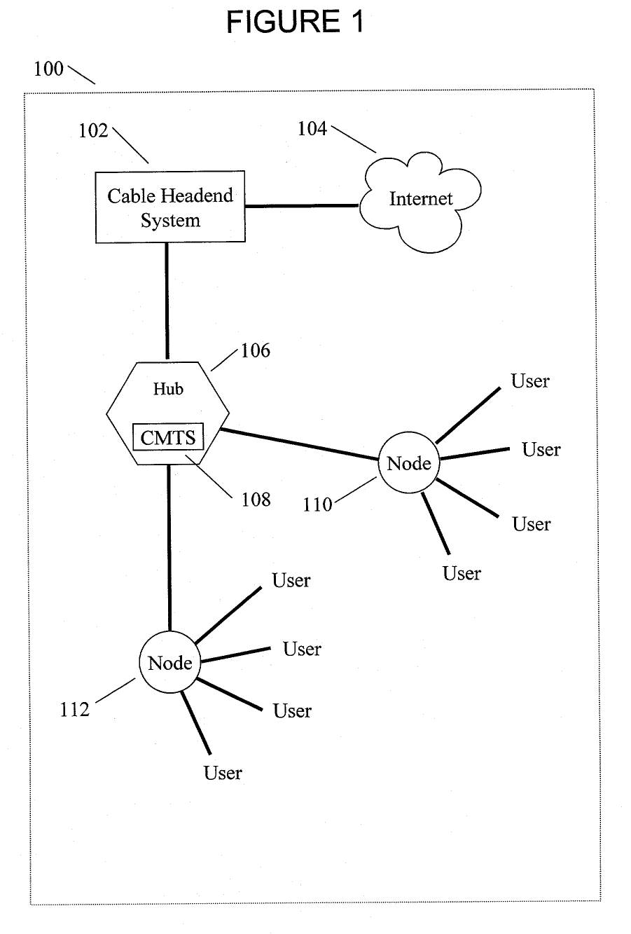

FIG. 1 illustrates a cable television network topology. Cable system 100 comprises cable headend system 102 that may be coupled to Internet 104 via a WAN or other network. Cable headend system 102 is connected to hub 106. Hub 106 may include a cable modem termination system (CMTS) 108. The CMTS provides send and receive functions to communicate with cable modems. Node 110 and node 112 are connected to hub 106. A plurality of users are connected to node 110 and to node 112. The connection between headend system 102 and hub 106 is commonly fiber optic cable. The connection between hub 106 and node 110 and node 112 may be fiber optic cable or coaxial cable. The connection between node 110 and node 112 and users is typically coaxial cable. Users connected to node 110 and node 112 may receive television signals, receive and transmit data, or both. FIG. 1 is illustrative of the architecture of cable television networks. Actual implementations may employ a plurality of hubs. Further, some implementations may comprise a CMTS unit or units installed at the cable headend 102. The number of users connected to a node may be on the order of 500 users.

Typically, cable modems send and receive data employing two different methods. In the downstream direction, digital data is modulated and then placed on a standard 6 MHz television channel, i.e., a channel located between 50 MHz and the upper broadcast range, usually between 550 MHz and 850 MHz in present systems. Frequently, 64 QAM (Quadrature Amplitude Modulation) is the preferred downstream modulation technique, offering up to 27 Mbps of data per 6 MHz channel. This signal may be placed in a 6 MHz channel adjacent to TV signals on either side without disturbing the cable television video signals. As demand for bandwidth increases, the cable operator may employ other modulation modes such as 256 QAM for downstream transfers, thereby providing up to 38 Mbps of data throughput per 6 MHz channel The upstream channel usually employs QPSK (Quadrature Phase Shift Keying) modulation. In most two-way cable networks, the upstream (also known as the reverse path) is transmitted at a frequency between 5 and 42 MHz. This frequency range tends to be a noisy environment, particularly at the lower and upper end of the range, exhibiting RF interference and impulse noise as may be generated by electric motors, switches, and other sources. Interference may be introduced in the home, due to loose connectors, corrosion, or poor cabling. As shown in FIG. 1, cable networks are linear networks that are commonly configured as tree and branch networks. As such, noise adds together as signals travel upstream, resulting in a noisier environment. Due to noise in the upstream range, most systems employ QPSK or a similar robust modulation schemes since QPSK provides greater noise immunity than higher order modulation techniques such as 16 QAM. The drawback is that QPSK provides a lower data transfer rate for a specified RF channel than 16 QAM.

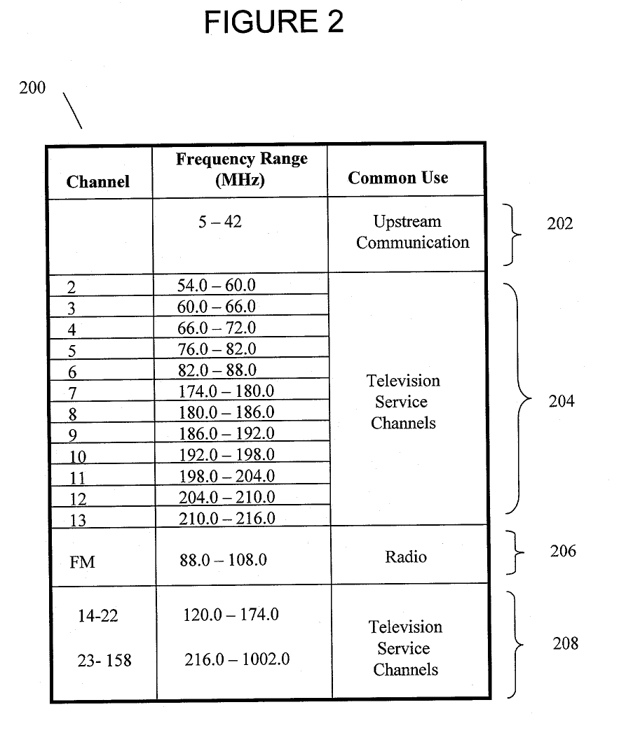

FIG. 2 depicts NTSC cable television frequencies 200. Upstream data transfers may employ the 5-42 MHz range of frequency group 202. Frequency group 204 depicts frequencies employed by VHF television channels. Frequency group 206 depicts frequencies that may be employed to carry FM radio. Frequency group 208 depicts frequencies used for television channels 14 to 158. Downstream data transfers may employ a frequency corresponding to an unused television channel. As noted earlier, cable modems commonly employ 64 QAM in a 6 MHz band for downstream data transfers, allowing up to 27 Mbps rates while upstream communications may employ QPSK in a 3.2 MHz band, allowing up to 5.12 Mbit/sec data rates.

Cable modems may be configured such that upon power-up, they may monitor one or more downstream channels for configuration information that is transmitted by a CMTS. Configuration information may include assignment of send and receive channels, the frequency, delay, and output power level employed when transmitting, plus a timeslot of when the modem may transmit is assigned. As noted above, the downstream channel is typically a 6 MHz bandwidth channel, while the upstream channel may be configured with a bandwidth that corresponds to the slowest transfer rate modem (DOCSIS 1.0) or to a bandwidth that corresponds to a higher transfer rate modem (DOCSIS 1.1 and higher). The term ‘CMTS upstream channel’ refers to the configured upstream channel and as such may vary in bandwidth and frequency depending on the capability of modems and depending on cable characteristics such as noise. A CMTS will typically configure a plurality of modems, each with a unique timeslot on their assigned channel. A plurality of CMTS channels may be supported, typically with a plug-in card for each channel or group of channels. As such, the system may be viewed as employing an FDMA/TDMA format where there may be a plurality of frequency bands (channels) allowing frequency division multiplexed access, and in each channel frequency, timeslots may be allocated to each modem assigned to that channel. Due to the cost of CMTS equipment, a cable system operator may install a CMTS with a single transmit channel and a single receive channel until the number of cable modem users, and associated revenue, prompt installation of an additional channel card or cards.

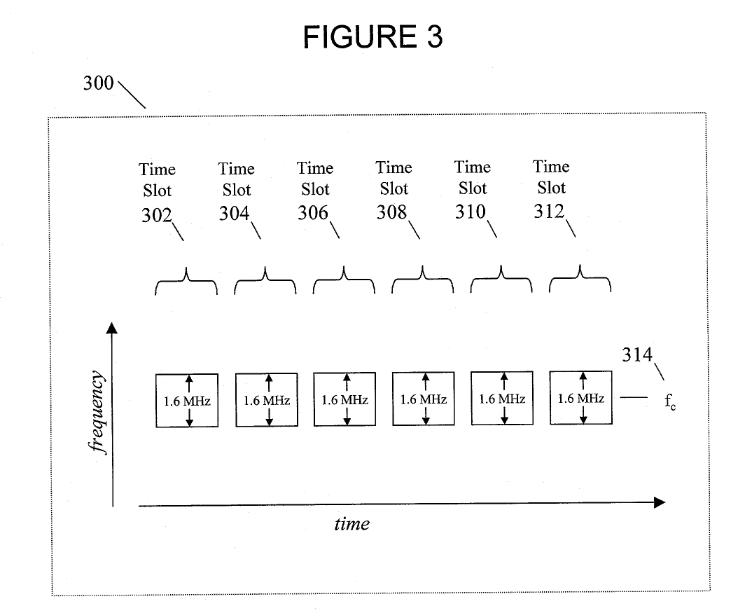

FIG. 3 is a depiction of DOCSIS 1.0 compliant modem upstream data transmission. Each of a plurality of modems transmits data in predefined timeslots 302-312. In a manner consistent with DOCSIS 1.0, all modems are configured to transmit at the same data rate and employ the same center frequency f_{c} 314. For example, if the CMTS system is capable of operating at 3.2 MHz, but some modems operate at 1.6 MHz, then all modems must operate at 1.6 MHz. This results in the capabilities of higher performance modems, such as a modem capable of transferring data at 3.2 MHz, for example, not being utilized. In FIG. 3, the CMTS upstream channel and corresponding receiver section of a CMTS unit may be configured to operate with a 1.6 MHz bandwidth. Although timeslots are depicted as being of equal length, in some implementations the duration of timeslots may vary. In the aforementioned situation of a single channel CMTS, the time multiplexing depicted in FIG. 3 may comprise hundreds of users each assigned a portion of the available bandwidth.

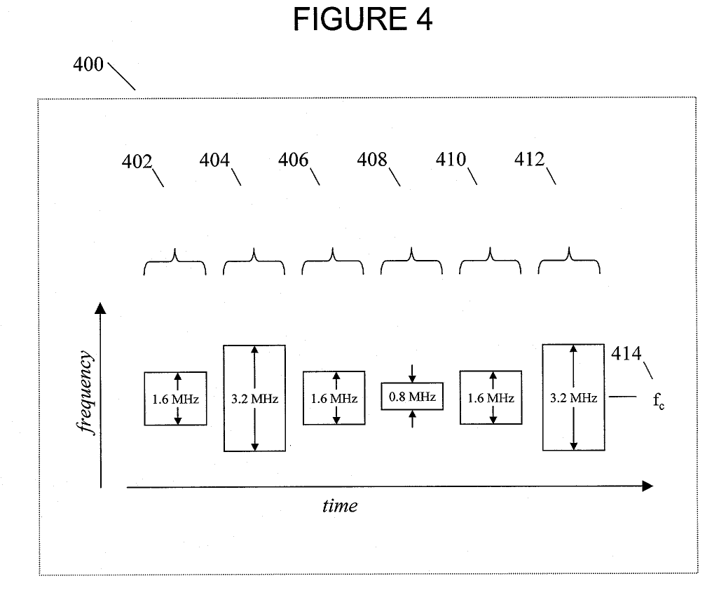

FIG. 4 is a second depiction of modem upstream data transmission comprising timeslots 402-412 in a single upstream channel. The CMTS upstream channel is configured as a 3.2 MHz channel with a center frequency f_{c} 414. The CMTS is capable of supporting modems operating at different data rates. The depicted modem transmission may employ the same center frequency f_{c} 414. One modem transmits in each timeslot 402, 404, 406, 408, 410, 412. Although timeslots 402-412 are depicted as being of equal length, in some implementations the duration of timeslots may vary. When a modem assigned to a timeslot does not transmit at the maximum bandwidth of the channel (3.2 MHz in this example), the remaining bandwidth is unused. While support of multiple data rates helps improve performance by allowing some modems to operate at higher data rate, thereby requiring less time to transfer data and freeing up timeslots for other users, the method depicted in FIG. 4 has the detraction that modems operating at less than the maximum data rate waste available bandwidth.

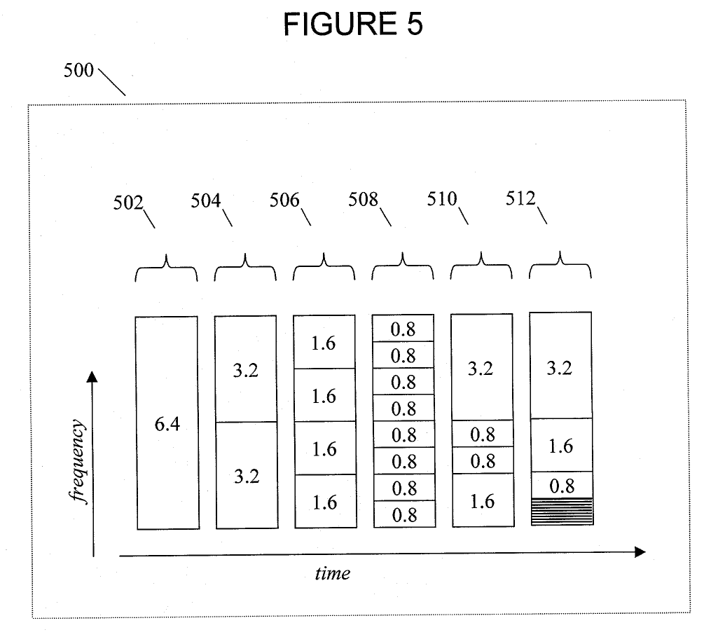

FIG. 5 depicts upstream data transmission in timeslots 502-512. The CMTS upstream channel is configured as a 6.4 MHz channel. At timeslot 502, a single modem transmits at the maximum channel data rate of 6.4 MHz. At timeslot 504, two modems each transmit in a separate 3.2 MHz band. Each 3.2 MHz band is a sub-channel. The term sub-channel refers to a portion of the CMTS upstream channel, wherein a plurality of sub-channels may occupy the channel. As shall be further described, sub-channels may be of different bandwidth, may employ different center frequencies, and may employ same or different encoding formats. The transmission depicted at timeslot 504 may also be representative of a single modem transmitting in two 3.2 MHz sub-channels, allowing the modem to achieve a 6.4 MHz transfer rate while maintaining a DOCSIS compatible symbol rate of 2.56 million symbols per second. As shown in FIG. 5, a plurality of modems can transmit simultaneously within a single upstream channel. At timeslot 506 of FIG. 5, four modems, each with a 1.6 MHz bandwidth, occupy the 6.4 MHz bandwidth upstream channel. The bandwidth of the modems in a channel need not be the same, as illustrated in timeslot 510 and timeslot 512. Advantageously, the present invention allows the full bandwidth of a channel to be utilized by multiple modems that do not have to operate at the same frequency or bandwidth.

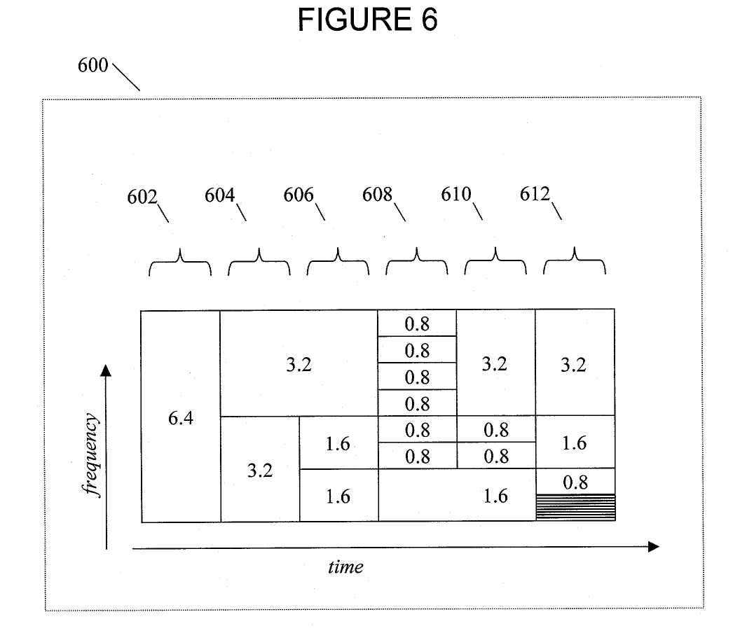

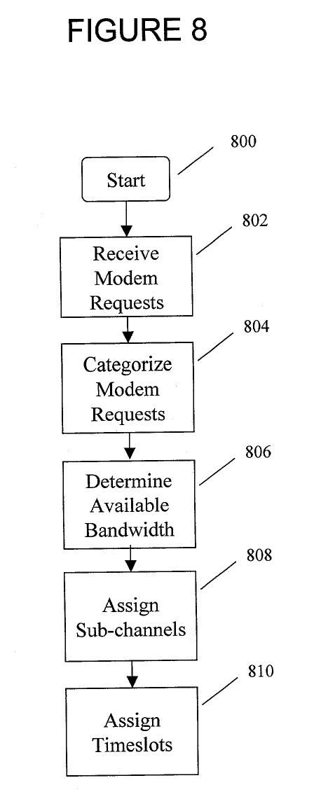

FIG. 6 depicts upstream data transmission in timeslots 602-612 that comprise another embodiment. In timeslot 602 a single modem utilizes the full CMTS upstream channel bandwidth, depicted as 6.4 MHz. In timeslot 604, two modems each transmit in a 3.2 MHz sub-channel within the 6.4 MHz bandwidth of the upstream channel. In timeslot 606 of FIG. 6, a modem that transmitted at 3.2 MHz during timeslot 604 continues to transmit, and two other modems each transmit in a 1.6 MHz sub-channel, occupying the full 6.4 MHz bandwidth of the upstream channel. As shown in timeslots 604-612, the bandwidth of the modems in a given channel need not be the same, nor does the duration of transmission need to be the same for modems transmitting simultaneously, such that a single modem may occupy two or more contiguous timeslots. Advantageously, the full bandwidth of a channel can be utilized and modems can occupy multiple contiguous timeslots. Dynamic allocation of timeslots can be provided based upon priority and other factors, as disclosed below with respect to the description of FIG. 8.

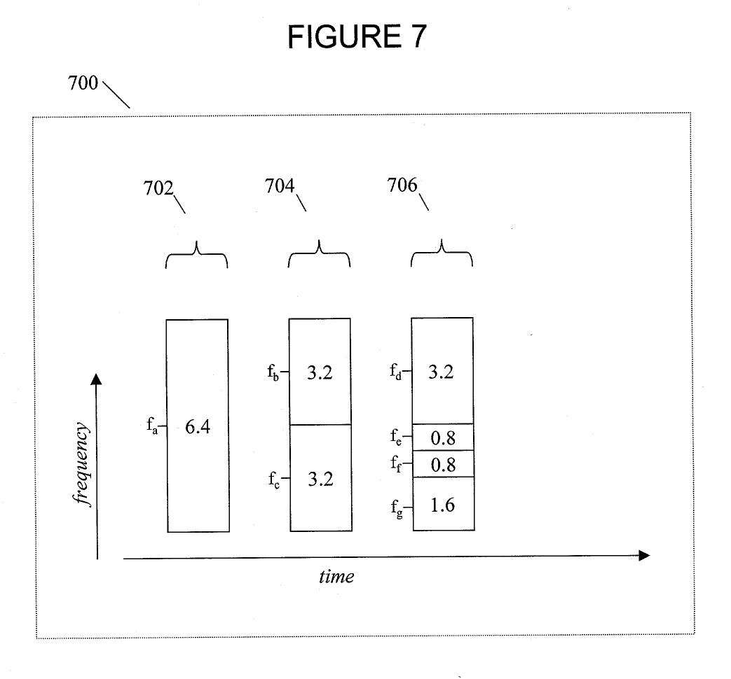

FIG. 7 illustrates the manner in which a center frequency can be assigned for each modem to implement the various embodiments disclosed herein. In timeslot 702, a single modem transmits at a center frequency of fₐ. In timeslot 704, two modems transmit, one with a center frequency of f_{b} and another with a center frequency of f_{c}. In timeslot 706, four modems transmit simultaneously employing center frequencies f_{d}, fₑ, f_{f}, and f_{g}. The center frequencies are assigned by the CMTS. The CMTS may be located in a hub or other locations as disclosed below. The modems are constructed so that they may compatibly operate on multiple center frequencies as shown with other modems that only have one center frequency of operation. Although the figures illustrate all of the available 6.4 MHz bandwidth being utilized by one or more modems, a configuration wherein one or more modems utilize less than 6.4 MHz is also supported. Further, the timeslots shown in FIG. 7 may be contiguous, or may have ‘gaps’ or periods of inactivity between them, as may occur in early morning hours when there may be fewer users. Timeslots are depicted as having similar boundaries for each sub-channel; however, the present invention also encompasses timeslot boundaries that may differ for each sub-channel. It should also be noted that assigned center frequencies may comprise one or more frequencies as depicted in FIG. 4, with additional sub-channel center frequencies above and or below the center frequencies of FIG. 4 in which additional modems may transmit. In this manner, compatibility with existing end user equipment may be provided while achieving the benefits of increased bandwidth utilization.

FIG. 8 depicts a method of servicing modem data transfer requests in accordance with the present invention. At step 802, a CMTS receives a plurality of data transfer requests from a plurality of modems attached to a cable network. These may be viewed as a stream of requests that may occur during contention timeslots, at which time other modems attached to the system may also request upstream data transfer bandwidth, or may occur as part of another transfer. The bandwidth request may typically include a request for an amount of bandwidth desired and may be expressed as a number of timeslots. Bandwidth may be determined from the modem ID (identification), such that a CMTS may determine the bandwidth configuration of the modem making the request, and the number of timeslots indicated in the request. At step 804, an algorithm may be employed to categorize the modem requests in terms of the amount of bandwidth requested, type of service, and other information. The type of service may comprise ‘best effort’ modes for non-time critical data transfers and may comprise QoS (Quality of Service) modes for time-critical transfers such as voice data transfers, for example. At step 806, the available bandwidth may be determined. Such determination may include bandwidth associated with sub-channels and timeslots previously assigned. At step 808, the CMTS assigns sub-channels that may reflect the number of requests, type of requests, bandwidth requested, and available bandwidth. Assignment of sub-channels may comprise configuring modems with center frequencies and bandwidths. In accordance with the present invention, modems that request larger data transfers may be allocated timeslots in larger bandwidth sub-channels, or the entire bandwidth of the channel, and modems requesting voice data transfer service may be assigned lower bandwidth sub-channels. At step 810, timeslots associated with each sub-channel may be assigned. In the above-described manner, the method of the present invention may be employed to dynamically (i.e. in a flexible, responsive, and programmable manner) assign sub-channels and timeslots in consideration of available bandwidth and the number and nature of modem requests. In other words, dynamic allocation of bandwidth may allow higher priority messages to employ larger sub-channels and/or multiple contiguous timeslots, especially when fewer high priority requests are made. Further, smaller bandwidth voice transmission can be transmitted using QoS mode that may necessitate designation of a small sub-channel in a designated channel. As depicted in FIG. 6, the duration assigned to each modem may vary and may comprise timeslots of different length or sequences of contiguous timeslots. The servicing of bandwidth requests in accordance with the present invention need not conform to the exact nature or order shown in FIG. 8. The bandwidth determination of step 806 may be replaced by a predefined value that reflects the number of channels available. Step 804 may be realized by providing different request processing for different types of requests.

The embodiments disclosed herein are substantially different from single modem per channel systems where a pool of timeslots are allocated to a plurality of pre-configured modems employing an algorithm reflecting modem speed and type of request, such as QoS and best effort. In contrast, the embodiments disclosed herein may be employed to dynamically allocate a plurality of sub-channels of same or differing size and same or differing duration such that the characteristics of sub-channels, including bandwidth and latency, may be tailored to reflect the type of modem requests received, so that higher bandwidth utilization is provided compared to single modem per channel architectures. As is the case for present CMTS systems, bandwidth allocation algorithms may vary considerably among CMTS vendors. The scheduling information determined by the CMTS algorithm may be employed by a CMTS receiver to define the composition of signals received in a particular time period and frequency range.

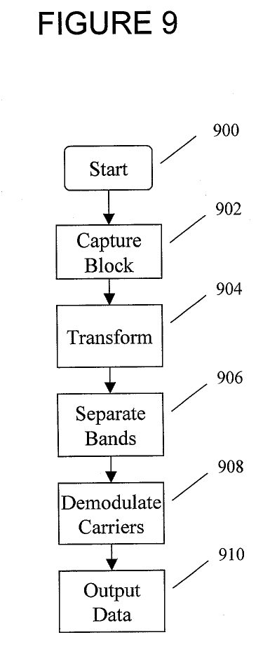

FIG. 9 depicts the steps performed by a channel receiver that may be implemented as part of a CMTS system. The process starts at step 900. At step 902, data from the channel is sampled and may be saved or buffered as a data block. At step 904, a transform is applied to the data block to produce frequency information. The transform may employ an FFT, DCT, or other transform and may employ windowing to reduce edge effects. At step 906 the frequency information is separated into bands corresponding to the center (carrier) frequencies employed during the sampled interval. At step 908 the bands are demodulated employing QPSK, QAM, or other formats. At step 910, data is output for each band.

As noted previously, an advantage of the present invention is that it allows a plurality of modems to transmit simultaneously within the same channel and dynamically be assigned a sub-channel bandwidth. In other words, the CMTS can determine the priority of requests for bandwidth, the amount of requested bandwidth and use a set of rules for assigning sub-channels and timeslots on a periodic basis to maximize the utilization of the frequency channel. Again, a processing unit, in the CMTS or another location, can perform dynamic allocation in this manner, and on a constantly changing basis depending upon number of users, type of transfer requests, network loading, etc. The CMTS can then assign center frequencies and bandwidth allocation for each modem using the frequency channel. When modems are configured to transmit at a low data rate, many modems may share the same timeslot. Modem data rate and frequency of timeslots may be configured such that modems transmit frequent short bursts of data. Such configurations are well suited to voice transfers where the volume of data transferred is relatively low, but latency must be low to preserve the real-time interaction of a conversation. A single upstream channel may be employed to carry a large number of voice channels. For example, if an 8 kHz sample rate at 8 bits per sample is employed for each voice signal, a single 3.2 MHz QPSK channel, providing a 2.56 MHz symbol rate and 5.12 Mbits/sec data rate using QPSK, may be employed to carry up to 80 voice signals without compression, ignoring framing and other overhead. Upstream channels may be shared between voice services and other data services.

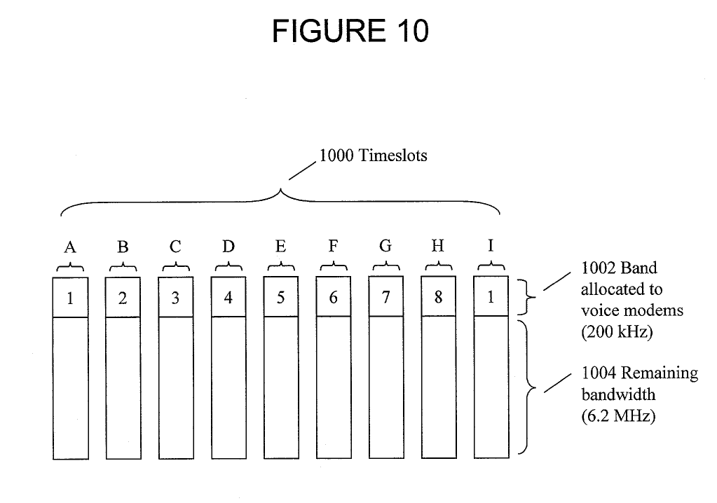

FIG. 10 depicts a cable television network channel configured for voice information transfer. A group of eight modems (not depicted) are configured to each successively utilize a portion of band 1002. Timeslots 1000 are labeled A through I. Associated with timeslots A through H are numerals 1 through 8, indicating the number of a modem utilizing the timeslot. At timeslot I, modem 1 again transmits. Band 1002 comprises a 200 kHz subchannel within a 6.4 MHz channel. Remaining bandwidth 1004 provides 6.2 MHz that may be utilized for other data transfer. Since band 1002 is a 200 kHz band, it may be employed to carry 160K symbols/sec in a DOCSIS compliant manner. If a QPSK format is employed, 320 Kbits/sec of data may be transferred, allowing a time division multiplexed rate of 40 Kbits/sec for each modem. The duration of timeslots 1000 may be configured to limit the latency between data transfers and to limit audible effects associated with the latency. For example, timeslots of five millisecond duration would result in a latency of 40 milliseconds between transmissions for each modem.

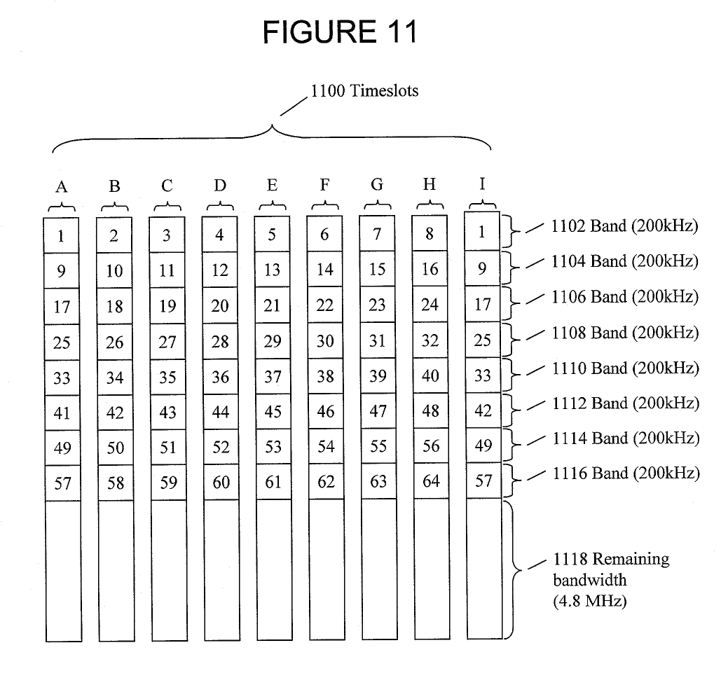

FIG. 11 depicts a cable television upstream channel configured to support 64 voice channels. Eight modems may each simultaneously transmit in each of the timeslots 1100 labeled A through I. Eight bands, 1102, 1104, 1106, 1108, 1110, 1112, 1114, and 1116 each support eight modems (not shown). In band 1102, modems 1 through 8 may transmit in timeslots labeled A through H respectively. At the timeslot labeled I, modem 1 may again transmit. In band 1104, modems 9 through 16 may transmit in timeslots labeled A through H respectively. At the timeslot labeled I, modem 9 may again transmit in band 1104. Similarly, modems 17 through 24 may transmit in band 1106, modems 25 through 32 may transmit in band 1108, modems 33 through 40 may transmit in band 1110, modems 41 through 48 may transmit in band 1112, modems 49 through 56 may transmit in band 1114, and modems 57 through 64 may transmit in band 1116. In the depicted configuration, each modem may transmit in every eighth timeslot. The eight bands are 200 kHz each and utilize 1.6 MHz of the 6.4 MHz channel, allowing 4.8 MHz for other data transfers.

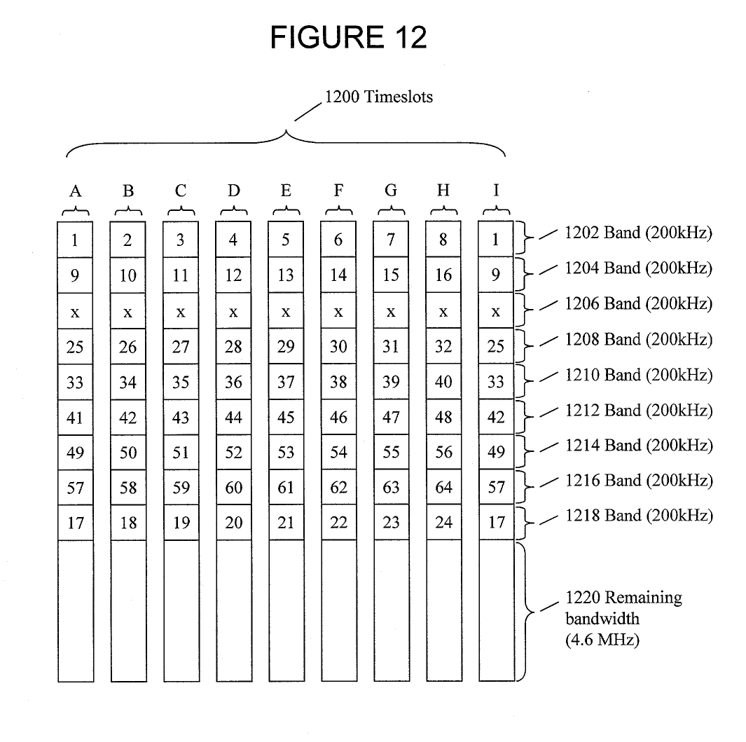

FIG. 12 depicts a cable television upstream channel configured to support 64 voice channels with band relocation. Similar to FIG. 11, timeslots 1200 labeled A through I each support eight modems (not depicted) employed for voice information transfer. As described earlier, modem upstream data transfers typically employ a QPSK format in the 5-42 MHz range. Since this is a potentially noisy environment, some data transfers may be corrupted by noise at a frequency within the band. If a band is determined to contain noise or other impairments that interfere with data transfers, as may be indicated by an error rate that is greater than or equal to a predetermined value, modems may be reassigned from that frequency band to another frequency band. A software program contained in a cable modem termination system or hub, headend system, modem, or elsewhere may determine an error rate. In FIG. 12, modems 17 through 24 have been reassigned from band 1206 to band 1218. Band 1206 is unused such that 4.6 MHz bandwidth remains that may be utilized by other modems. Band relocation may also be employed to avoid frequency ranges that may be employed for other transmission such as polling operations, for example. Some set top boxes may have a set polling frequency, such as 8.9 MHz, for example, which is employed to transfer information such as pay-per-view data. Polling operations or other transmissions may occur at regular intervals, such that modem services may employ the frequency ranges for part of the time.

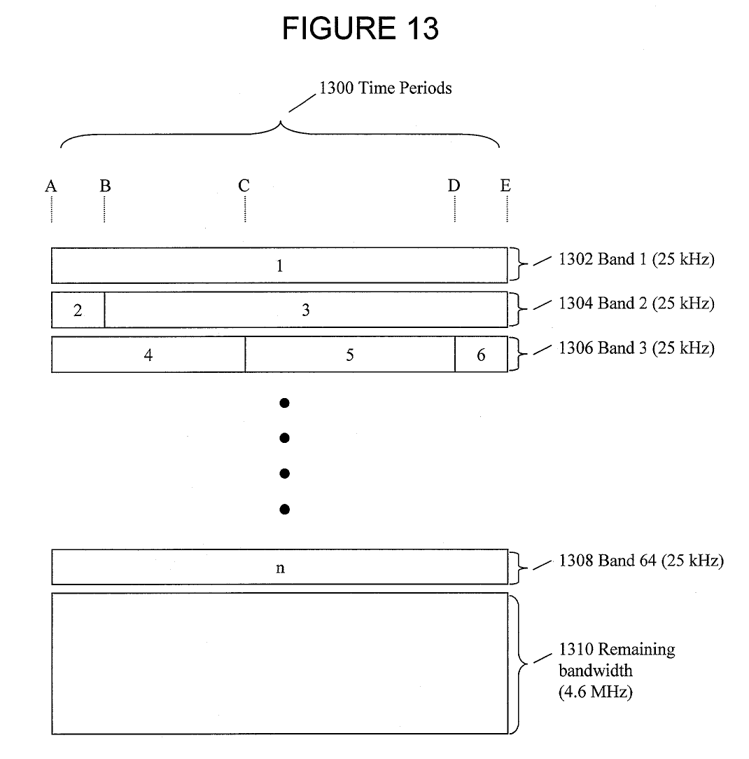

FIGS. 10 through 12 depict eight modems being time division multiplexed onto a 200 kHz band within a 6.4 MHz channel. The 200 kHz band(s) depicted may comply with the DOCSIS 1.0 specification. Depending on audio quality and encoding methods, such as ADPCM, for example, orders of multiplexing other than eight may be employed. If the frequency of the band is increased, a greater number of modems may be multiplexed with the same audio quality. If the frequency of the band is decreased, a fewer number of modems may be supported at the same audio quality. Further, the frequency of the band may be reduced to a point that a single modem employs the channel for voice information transfer. This configuration may be termed ‘always on’ and is described in FIG. 13.

FIG. 13 depicts an ‘always on’ configuration for 64 voice frequency channels where each voice channel may be viewed as a dedicated sub-channel. In contrast to the time division multiplexing depicted in FIGS. 8-10, the frequency width of a sub-channel band is configured such that it supports a single modem for voice information transfers. In other words, each sub-channel band supports one call at a time. After one call or portion of a call is completed, another call may occupy the sub-channel. Referring to FIG. 13, time periods 1300 are labeled A through E. In band 1 (ref 1302), a first call occupies the period from time A to time E. In band 2 (ref 1304), a second call occupies the period from time A to time B, and a third call occupies the period from time B to time . In band 3 (1306), a fourth call occupies the period from time A to time C, a fifth call occupies the period from time C to time D, and a sixth call occupies the period from time D to time E. The ‘one call at a time’ nature of this configuration may be termed single call per band. The number of bands is equal to the number of simultaneous conversations supported. As such there are 64 bands illustrated in FIG. 13, as indicated by ellipsis, ending with band 64 (1308). The frequency width of the bands may reflect desired audio quality and encoding methods employed. In FIG. 13, a frequency width of 25 kHz is depicted, resulting in remaining bandwidth 1310 of 4.6 MHz. While not compliant with DOCSIS 1.0, this configuration has the potential advantage that if noise results in band relocation, the unused bandwidth is less than that of the 200 kHz or greater bandwidth of compliant systems. This configuration may also result in greater data transfer efficiency through use of maximum length data transfers such that transfer overhead is a smaller portion of utilized bandwidth.

The afore-described embodiments provide a significant new system and method to achieve higher bandwidth and efficiencies for data transfer in cable systems without requiring changes to customer premises equipment. The greater bandwidth efficiency may allow cable operators to support additional customers at lower cost, and may allow a cable operator to provide new or additional services without significant additional cost. The processing depicted in FIG. 9 may employ a down converter such that signals from a channel are converted to a frequency width of the channel being processed prior to digitization. Alternately, the processing of FIG. 9 may digitize a wide frequency range, such as the aforementioned 5 to 42 MHz range employed for cable upstream transfers, for example, and process and demodulate a plurality of bands contained in a plurality of channels. As the processing power of digital signal processors increases, a single receiver may be employed to process all channels. Further, as cable network topologies evolve, upstream communication paths may employ less noise sensitive cabling (such as fiber optic cable) or may employ architectures that reduce noise accumulation such that upstream modulation may employ higher order QAM modes, such as 8 QAM, 16 QAM, or 32 QAM for example, or other formats that provide a greater number of bits per symbol than QPSK. The benefits of simultaneous transmission by a plurality of modems within a single channel furnished by the above embodiments may also be realized by configuring a plurality of CMTS cards for each channel. For example, a first CMTS card may be configured to define a 6.4 MHz upstream channel and to support modems that utilize the full 6.4 MHz bandwidth and a second CMTS card may be configured to support modems that utilize the upper 3.2 MHz of the 6.4 MHz channel and a third CMTS card may be configured to support modems that utilize the lower 3.2 MHz of the 6.4 MHz channel. The above disclosure has employed descriptions of cable modem operation and has employed descriptions of NTSC cable frequency allocation. The method of the present invention is not limited to a particular standard, channel width, or signaling format, and may be employed in Phase Alternating Line (PAL), Systeme Electronique Couleur Avec Memoire (SECAM), and other formats and further may be applied to any system capable of upstream data transmission on a cable network. Further, there is no requirement that the cable system carry television signals and as such the invention may be employed in cable data networks. Embodiments of the present invention may employ S-CDMA (synchronous code division multiple access) that is a version of code division multiple access (CDMA), developed by Terayon Corporation that is headquartered in Santa Clara Calif., for data transmission across coaxial cable networks. S-CDMA may be viewed as a spread time/spread spectrum format wherein data is transferred in different bands at different times.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of transferring data from a plurality of modems upstream in a cable network in timeslots having a predetermined maximum bandwidth comprising:
receiving requests to transmit said data from said plurality of modems on a cable modem termination system that includes information relating to operational parameters of said plurality of modems, required bandwidth of said transmission and priority data;
selecting channels and sub-channels for said plurality of modems based upon said operational parameters of said plurality of modems by said required bandwidth and said priority data; and
assigning said channels and sub-channels by assigning center frequencies and bandwidth for each of said modems in said timeslots.

2. A method of transferring data upstream over a cable network comprising:
configuring a first cable modem to transmit at a first carrier frequency providing a first bandwidth during at least one timeslot of a plurality of timeslots;
configuring a second cable modem to transmit at a second carrier frequency and at a second bandwidth during said at least one timeslot wherein said first bandwidth is not equal to said second bandwidth, and said first and second carrier frequencies are within a single upstream channel of said cable network;
transmitting first data from said first modem at said first carrier frequency during said at least one timeslot; and
transmitting second data from said second modem at said second carrier frequency during said at least one timeslot.

3. The method of claim 2 further comprising:
configuring at least one additional cable modem to transmit at least one additional carrier frequency during said at least one timeslot; and
transmitting at least one additional data set from said one additional cable modem at said at least one additional carrier frequency during said at least one timeslot.

4. The method of claim 2 further comprising:
configuring a third cable modem to transmit at a third carrier frequency during a second timeslot of said plurality of time slots, wherein said third carrier frequency is different from said first carrier frequency and said second timeslot is after said at least one timeslot;
continuing transmission by said first modem during said second timeslot;
suspending transmission by said second modem during said second timeslot; and
transmitting third data by said third cable modem at said third carrier frequency during said second timeslot.

5. The method of claim 2 further comprising:
receiving a transmission that encompasses both said first carrier frequency and said second carrier frequency;
digitizing said transmission to produce a block of data; and
processing said block of data to recover said first data and said second data.

6. The method of claim 5 wherein said step of processing further comprises:
applying a transform to said block of data to convert between time and frequency domains.

7. The method of claim 5 wherein said step of processing further comprises:
applying a demodulating algorithm to data corresponding to a predetermined frequency range.

8. A method of transferring data over a cable network comprising:
receiving a plurality of data transfer requests from a plurality of modems;
assessing bandwidth available for data transfers;
allocating a first sub-channel and a plurality of first timeslots to a first modem in response to the amount of bandwidth requested; and
allocating a second sub-channel and a plurality of second timeslots to a second modem in response to the amount of bandwidth requested by said second modem wherein said first sub-channel and said second sub-channel are within a single cable system upstream channel and said first and second sub-channels are of different bandwidth, and at least one timeslot of said first plurality of timeslots coincides with at least one timeslot of said second plurality of timeslots.

9. The method of claim 8 wherein said allocating a first sub-channel is further responsive to the number of modem requests to be serviced.

10. The method of claim 8 wherein said allocating a first sub-channel is further responsive to the type of data transfer requested by said first modem.

11. The method of claim 8 further comprising:
receiving a transmission that encompasses both said first sub-channel and said second sub-channel;
digitizing said transmission to produce a block of data; and
processing said block of data to recover data transmitted by said first modem and said second modem.

12. The method of claim 11 wherein said step of processing further comprises:
applying a transform to said block of data to convert between time and frequency domains.

13. A method of transferring voice data over a cable network comprising:
receiving a request from a first cable modem for voice information transfer;
receiving a request from a second cable modem for voice information transfer;
configuring said first cable modem to transmit first voice information in a first sub-channel contained within a cable system upstream channel;
configuring said second cable modem to transmit second voice information in a second sub-channel contained within said cable system upstream channel, wherein said first sub-channel and said second sub-channel are of different frequencies;
allocating a first plurality of contiguous timeslots to said first modem; and
allocating a second plurality of contiguous timeslots to said second modem wherein at least one timeslot of said first plurality of timeslots is concurrent with at least one timeslot of said second plurality of timeslots.

14. The method of claim 13 wherein said first plurality of contiguous timeslots is at least equal in duration to a spoken phrase.

15. The method of claim 13 further comprising:
receiving a transmission comprising said upstream channel;
digitizing said transmission to produce a block of data; and
processing said block of data to obtain said first voice information and said second voice information.

16. The method of claim 13 further comprising:
determining an error rate for said first sub-channel; and
configuring said first modem to transmit in a third sub-channel contained within said upstream channel if said error rate is greater than or equal to a predetermined value, wherein said third sub-channel is not equal in frequency to said first sub-channel and is not equal in frequency to said second sub-channel.

17. The method of claim 16 further comprising:
receiving a transmission comprising said channel;
digitizing said transmission to produce a block of data; and
processing said block of data to discern said first voice information and said second voice information.

18. A system for transferring information across a cable network comprising:
a first cable modem that transmits first data in a first sub-channel in a cable system upstream channel during a timeslot;
a second cable modem that transmits second data in a second sub-channel in said cable system upstream channel during said timeslot wherein the bandwidth of said first sub-channel is not equal to the bandwidth of said second sub-channel;
a receiver that receives transmissions in said channel;
a digitizer that digitizes said transmissions to produce a data block; and
a processing unit that processes said data block to retrieve said first data and said second data.

19. The system of claim 18 wherein said processing unit further applies a transform to said data block to covert data from time domain to frequency domain.

20. The system of claim 18 further comprising:
a cable modem termination system that configures said first modem and said second modem.

21. The system of claim 20 wherein said cable modem termination system configures said first modem in response to a request from said first modem.

22. The system of claim 20 wherein said cable modem termination system further comprises:
a software routine that determines an error rate for said first sub-channel and assigns said first modem to a third sub-channel if said error rate is greater than or equal to a predetermined value.

23. A method of transferring data over a cable system network comprising:
receiving a plurality of upstream data transfer requests from a plurality of modems;
dynamically establishing a transmit schedule comprising a first subchannel and first plurality of timeslots allotted to a first modem of said plurality of modems and a second sub-channel and a second plurality of timeslots allocated to a second modem of said plurality of modems wherein said first sub-channel and said second sub-channel are contained within a single upstream channel, and said first sub-channel and said second sub-channel are not equal in bandwidth, and at least one timeslot of said first plurality of timeslots is concurrent with at least one timeslot of said second plurality of timeslots; and
configuring said first modem to transmit on said first sub-channel during said first plurality of timeslots.

24. The method of claim 23 wherein said first sub-channel is of different bandwidth than was previously assigned to said first modem.

25. A method of transferring data over a cable system network comprising:
receiving a plurality of upstream data transfer requests from a plurality of modems;
establishing a transmit schedule comprising a first sub-channel and first plurality of timeslots allotted to a first modem of said plurality of modems and a second sub-channel and a second plurality of timeslots allocated to a second modem of said plurality of modems wherein said first sub-channel and said second sub-channel are contained within a single upstream channel, and said first sub-channel and said second sub-channel are not equal in bandwidth, and at least one timeslot of said first plurality of timeslots is concurrent with at least one timeslot of said second plurality of timeslots;
receiving a transmission from said upstream channel comprising said first plurality of timeslots and said second plurality of timeslots; and
employing said transmit schedule to recover data transmitted by said first modem and said second modem.

26. A method of transferring voice data over a cable network comprising:
receiving a stream of modem upstream data transfer requests comprising a plurality of voice data requests and a plurality of non-voice data requests;
configuring a first cable modem to transmit voice data at a first carrier frequency in a plurality of contiguous timeslots at a predefined time;
configuring a second cable modem to transmit voice data at a second carrier frequency in said plurality of contiguous timeslots;
transmitting first voice data over said cable network from said first modem at said first carrier frequency in said plurality of contiguous timeslots;
transmitting second voice data over said cable network from said second modem at said second carrier frequency in said plurality of contiguous timeslots;
determining if a scheduled transmission will interfere with said first carrier frequency;
configuring said first modem to transmit data at a third carrier frequency during at least one of said plurality of contiguous timeslots if said scheduled transmission will interfere with said first carrier frequency; and
transmitting data from said first modem at said third carrier frequency.

27. A method of processing cable system upstream data transmissions comprising:
configuring a first cable modem termination system receiver to process data from a first sub-channel contained in a cable system upstream channel during at least one timeslot; and
configuring a second cable modem termination system receiver to process data from a second sub-channel contained in said cable system upstream channel during said at least one timeslot, wherein the bandwidth of said first sub-channel is not equal to the bandwidth of said second sub-channel.

28. A method of transferring data upstream over a cable network comprising:
configuring a cable modem termination system to define an upstream channel in said cable network;
configuring a first cable modem to transmit at a first carrier frequency providing a first bandwidth;
configuring a second cable modem to transmit at a second carrier frequency and at a second bandwidth wherein said first bandwidth is not equal to said second bandwidth, and said first and second carrier frequencies are within said upstream channel of said cable network; and
concurrently transmitting first data from said first modem at said first carrier frequency and transmitting second data from said second modem at said second carrier frequency.

29. The method of claim 28 further comprising:
stopping transmitting by said first modem and continuing transmitting second data from said second modem.
